(19) United States
(12) Patent Application Publication
(10) Pub. No.: US 2024/0412207 A1
(43) Pub. Date: Dec. 12, 2024

(54) Composable Digital Assets

(71) Applicant: Frontage Road Holdings, LLC, Wilmington, DE (US)

(72) Inventors: Josh Williams, Sacramento, CA (US); Raymond A. Chiapuzio, Eugene, OR (US)

(21) Appl. No.: 18/399,320

(22) Filed: Dec. 28, 2023

Related U.S. Application Data
(60) Provisional application No. 63/477,733, filed on Dec. 29, 2022.

(51) Int. Cl. G06Q 20/38; G06Q 20/36; G06Q 20/40

(52) U.S. Cl. CPC G06Q 20/389; G06Q 20/367; G06Q 20/405

(57) ABSTRACT

A computer-based system, computer-implemented method, and computer program product for establishing an instantaneous computational value of an asset cluster leverage a composable asset control system implemented upon one or more blockchain computer networks. The composable asset control system is configured to resample a non-fungible digital asset and a digital representation of a cryptographic asset. The composable asset control system is further configured to configure an asset cluster by configuring a binding secured by the blockchain computer network. The composable asset control system is further configured to quantify an instantaneous computational value of the asset cluster based on a value of the cryptographic asset. The composable asset control system is further configured to encode in at least one smart contract a regulator configured to control transfer and use of the asset cluster.

### RELATED APPLICATION

This application claims the benefit of U.S. Provisional Application No. 63/477,733, filed on Dec. 29, 2022. The entire teachings of the above application are incorporated herein by reference.

### BACKGROUND

A blockchain may be implemented as a peer-to-peer (P2P), electronic ledger that is implemented as a computer-based decentralized, distributed system made up of blocks, which, in turn, are made up of transactions. Each transaction may be a data structure that encodes a transfer of control of a digital asset between participants in the blockchain system, and that includes at least one input and at least one output. Each block may contain a hash of a previous block so that blocks become chained together to create a permanent, unalterable record of all transactions that have been written to the blockchain since its inception. Transactions may contain small programs, known as scripts, embedded into their inputs and outputs; the scripts may specify how and by whom the outputs of the transactions can be accessed.

Blockchain may be used for implementation of “smart contracts” that can be associated with digital asset. These are computer programs designed to automate execution of terms of a machine-readable contract or agreement. Unlike a traditional contract, which would be written in natural language, a smart contract is a machine-executable program that may include rules for processing inputs to generate results; these results may then cause actions to be performed depending upon those results. With respect to commercial transactions, for example, these may involve a transfer of property rights and/or assets.

An area of blockchain-related interest is the use of “tokens” to represent and transfer assets via the blockchain. A token serves as an identifier that allows an asset to be referenced from the blockchain. Fungible tokens are uniform. In other words, fungible tokens of the same type are identical in specification, and each fungible token is identical to another fungible token of the same type. Fungible tokens may be divisible into smaller amounts. Similar to currency, where bills can be divided into coins of an equivalent value, fungible tokens may be divisible. Non-fungible tokens (NFTs), however, cannot be replaced with other tokens of the same type. NFTs represent non-fungible assets. Non-fungible assets have unique information or attributes. Each NFT is unique and differs from other tokens of the same class, and, unlike a fungible token, NFTs typically cannot be divided. Blockchain gaming systems may use tokens or NFTs to create different parts of the game, such as rules, characters, weapons, and skins.

Cryptocurrency wallets may be implemented to securely store and manage blockchain assets, tokens, NFTs, and cryptocurrencies. These wallets may allow users to spend, receive, and trade digital assets.

### SUMMARY

In support of a robust blockchain-enabled asset exchange platform, it is desirable to be able to present a readily available value for digital assets such as non-fungible tokens (NFTs). It can be difficult to determine a value for such digital assets, as such a value may be volatile or otherwise nebulous within a given online marketplace. However, by furnishing such digital assets with an acceptable instantaneous value, increased stability in activity occurring across such online marketplaces can be achieved.

Embodiments thus include a computer-based system for establishing an instantaneous computational value of an asset cluster. In an example embodiment, the system includes a blockchain computer network with multiple nodes. A node of the multiple nodes of the blockchain computer network may be configured to execute a composable asset control system. The composable asset control system may be configured to resample, at the node of the multiple nodes, a non-fungible digital asset and a digital representation of a cryptographic asset. The composable asset control system may be further configured to configure an asset cluster by configuring a binding secured by the blockchain computer network. The binding may be configured to computationally pair the resampled digital representation of the cryptographic asset and the resampled non-fungible digital asset. The composable asset control system may be further configured to quantify an instantaneous computational value of the asset cluster based on a value of the cryptographic asset. The composable asset control system may be further configured to encode in at least one smart contract a regulator configured to control transfer and use of the asset cluster. The regulator may be further configured to control the asset cluster based on the quantified instantaneous computational value of the asset cluster. According to an example embodiment, the composable asset control system may be further configured to iteratively quantify the instantaneous computational value of the asset cluster responsive to a change in the value of the cryptographic asset.

In an example embodiment, the node of the multiple nodes of the blockchain computer network may include a secure cryptoprocessor implemented as a dedicated microprocessor configured to execute the composable asset control system. The composable asset control system may be embedded on the secure cryptoprocessor.

According to an example embodiment, the composable asset control system may be further configured to resample the non-fungible digital asset and the digital representation of the cryptographic asset by generating a first identifier (ID) for the non-fungible digital asset and a second identifier (ID) for the cryptographic asset. In another example embodiment, the first identifier (ID) may include a first cryptographic hash value and the second identifier (ID) may include a second cryptographic hash value.

In an example embodiment, the regulator may be further configured to computationally assign at least one attribute of the asset cluster. According to another example embodiment, the at least one attribute of the asset cluster may include (i) metadata relating to recordation of the asset cluster on the blockchain computer network, (ii) an identifier of the at least one smart contract, (iii) another property governing the instantaneous computational value, the transfer, or the use of the asset cluster, (iv) data governing use of the non-fungible digital asset in a gaming application, or (v) a combination thereof.

According to an example embodiment, the regulator may be further configured to computationally assign an owner node of the asset cluster. In another example embodiment, the regulator may be further configured to record a pairing between a user account of the owner node and the asset cluster in an electronic ledger of the blockchain computer network.

According to an example embodiment, the node of the multiple nodes may be further configured to execute an automated market maker (AMM) cryptographic system. The automated market maker (AMM) cryptographic system may be configured to facilitate a transaction with the node of the multiple nodes by transferring an ownership interest in the asset cluster to the automated market maker (AMM) cryptographic system upon receipt, at the node of the multiple nodes, of an exchange asset. The exchange asset may have an asset value that is equal to or greater than the instantaneous computational value of the asset cluster.

In an example embodiment, the node of the multiple nodes may be further configured to operate in connection with other nodes of the multiple nodes of the blockchain computer network. According to another example embodiment, the binding may be further configured to record an association between the resampled digital representation of the cryptographic asset and the resampled non-fungible digital asset in an electronic ledger of the blockchain computer network. In an example embodiment, the instantaneous computational value may be a minimum value. According to another example embodiment, the cryptographic asset may include at least a unit of cryptocurrency. In an example embodiment, the composable asset control system may be further configured to separate the non-fungible digital asset of the asset cluster from the digital representation of the cryptographic asset of the asset cluster by nullifying the binding secured by the blockchain computer network. According to another example embodiment, the instantaneous computational value may be equal to the value of the currency item. In an example embodiment, the cryptographic asset may include a fungible token native to an electronic ledger of the blockchain computer network.

In an example embodiment, the system may further include an online application, e.g., an online gaming application, configured to present an environment that supports utilization of, or exchange of, the asset cluster or a component thereof. The node of the multiple nodes may be further configured to interface with the online application. According to another example embodiment, the node of the multiple nodes may be further configured to interface with an application or a website of an asset transaction facilitation platform, e.g., a financial institution. In an example embodiment, the node of the multiple nodes may be further configured to interface with an exchange platform. The exchange platform may be configured to implement a transaction rule that governs the transfer and the use of the asset cluster. According to yet another example embodiment, the composable asset control system may be further configured to configure the binding secured by the blockchain computer network by recording a data structure to a data repository secured by the blockchain computer network. The data structure may include an identifier of the resampled non-fungible digital asset and an identifier of the resampled digital representation of the cryptographic asset.

Alternative computer-implemented method and computer program product embodiments parallel those described above in connection with the example computer-based system embodiments.

It should be understood that example embodiments disclosed herein can be implemented in the form of a computer-implemented method, apparatus, computer-based system, or computer program product.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIGS. 1 and 2 are block diagrams of example embodiments of a system for establishing an instantaneous computational value of a non-fungible digital asset.

FIG. 3 is a simplified block diagram of an example embodiment of a distributed blockchain ledger computer-implemented system.

FIG. 4 is a simplified block diagram showing exemplary blockchain layers according to an embodiment.

FIG. 5 is a simplified block diagram of an example implementation of a network in communication with an embodiment.

FIG. 6 is a simplified block diagram of any internal structure of a computer/computing node in a processing environment of an embodiment.

FIG. 7A is a simplified block diagram showing an example device authentication system according to an embodiment.

FIG. 7B is a diagram showing example system components for the example device authentication system according to an embodiment.

FIG. 7C is a diagram of the example device authentication system coupled with the example system components according to an embodiment.

FIG. 7D is a diagram of the example device authentication system adapter and its outward and inward-looking interfaces according to an embodiment.

FIG. 8 is a block diagram of an example embodiment of a system for establishing an instantaneous computational value of a non-fungible digital asset.

FIG. 9 is a flow diagram showing an example embodiment of a method of establishing an instantaneous computational value of a non-fungible digital asset.

FIG. 10 is a table illustrating an example data structure representing an asset cluster that may be recorded to a blockchain in one embodiment.

FIG. 11A is a diagram of a sequence of packaging and delivering an instruction according to an embodiment.

FIG. 11B is a diagram of a device enrollment process according to an embodiment.

FIG. 12 is a simplified block diagram of an example user identification system according to an embodiment.

FIG. 13 is a flow diagram of an exemplary computer-based system/method for establishing an instantaneous computational value of an asset cluster according to an embodiment.

### DETAILED DESCRIPTION

A description of example embodiments follows.

In general, blockchain is a write-once, append-many type electronic ledger. Blockchain is an architecture that allows disparate users to make transactions and creates an unchangeable record of those transactions. To move anything of value over any kind of blockchain, a network of nodes must first agree that a corresponding transaction is valid. As a peer-to-peer (P2P) network, combined with a distributed time-stamping server, blockchain ledgers can be managed autonomously to exchange information between disparate parties; there is no need for an administrator. In effect, the blockchain users are the administrator.

Blockchain's rapid development has given rise to many different kinds of chains, leading to cross-chain technology. Cross-chain, as its name suggests, allows the transmission of value and information between different blockchains. According to an example embodiment, a digital asset may be exchanged, cross-chain, securely, and despite differences between constraints or rules of operation that may be established for the different blockchains. Such a digital asset may be in the form of a token, which may be fungible, or may be a non-fungible token (NFT). Such constraints or rules may be in the form of smart contracts, or other forms. Differences between such constraints or rules may include disparate levels of rigor or leniency of such constraints or rules between or among different blockchain networks.

In some embodiments, blockchain may be a P2P, electronic ledger that is implemented as a computer-based decentralized, distributed system made up of blocks, which, in turn, are made up of transactions. Each transaction may be a data structure that encodes a transfer of control of a digital asset between participants in the blockchain system, and that includes at least one input and at least one output. Each block may contain a hash of a previous block so that blocks become chained together to create a permanent, unalterable record of all transactions that have been written to the blockchain since its inception. Transactions may contain small programs, known as scripts, embedded into their inputs and outputs; the scripts may specify how and by whom the outputs of the transactions can be accessed.

For a transaction to be written to the blockchain, it must be “validated.” Network nodes (miners) may perform work to ensure that each transaction is valid, with invalid transactions being rejected from the network. Software clients installed on the nodes may perform this validation work on an unspent transaction (UTXO) by executing its locking and unlocking scripts. If execution of the locking and unlocking scripts evaluates to TRUE, the transaction is valid and is written to the blockchain. Thus, for a transaction to be written to the blockchain, it should be: (i) validated by a first node that receives the transaction—e.g., if the transaction is validated, the node relays it to other nodes in the network; (ii) added to a new block built by a miner; and (iii) mined, e.g., added to the public ledger of past transactions.

Blockchain may be used for implementation of “smart contracts” that can be associated with digital assets. These are computer programs designed to automate execution of terms of a machine-readable contract or agreement. Unlike a traditional contract, which would be written in natural language, a smart contract is a machine-executable program that may include rules for processing inputs to generate results; these results may then cause actions to be performed depending upon those results. With respect to commercial transactions, for example, these may involve a transfer of property rights and/or assets. Such assets may include real property, personal property (including both tangible and intangible property), digital assets such as software, or any other type of asset. In the digital economy, there is often an expectation that exchanges and transfers will be performed in a timely manner and across vast distances. This expectation, along with practical, technical limitations, means that traditional forms of asset transfer, such as physical delivery of hardcopy of documents representing a contract, negotiable instrument, etc., or a tangible asset itself, are not desirable. Thus, smart contracts can provide enhanced control, efficiency, and speed of transfer.

An area of blockchain-related interest is a use of “tokens” to represent and transfer assets via the blockchain. A token thus serves as an identifier that allows a real-world item to be referenced from the blockchain. Through an initial coin offering (ICO) model, startups may raise capital by issuing tokens on a blockchain, such as Ethereum, and distributing them to token buyers in exchange for making a financial contribution to a project. These tokens, which may be transferred across a network and traded on cryptocurrency exchanges, may serve a multitude of different functions, from granting holders access to a service to entitling them to company dividends. Depending on their function, tokens may be classified as security tokens or utility tokens.

Further, similar to physical assets, the tokens that represent them may have many properties, one of which is fungibility or non-fungibility. In economics, fungibility refers to equivalence or interchangeability of each unit of a commodity with other units of the same commodity. Fungible tokens (FTs) are tokens that can be exchanged for any other token with the same value.

Fungible tokens are uniform, that is, FTs of the same type are identical in specification. In other words, each FT is identical to another FT of the same type, and FTs are divisible into smaller amounts. Similar to currency, where bills can be divided into coins of an equivalent value, FTs are divisible. As such, a fraction of an FT can be transferred between users. NFTs, however, cannot be replaced with other tokens of the same type. NFTs represent nonfungible assets, e.g., assets that have unique information or attributes. Each NFT is unique and differs from other tokens of the same class. For example, while plane tickets from and to a same destination may look the same, each one has a different passenger name, seat number, etc., and, therefore, is unique. In contrast to FTs, NFTs cannot be divided, an elementary unit of the NFT is the token itself.

Due to an immutable nature of transaction histories supported by blockchain networks, it is possible to extend the aforementioned validation steps of such transactions so that the transactions become subject to certain rules that reference prior transactions, or even aspects of an initial creation of a subject digital asset, e.g., a NFT. An example of such rules is an arrangement wherein royalties are paid to a creator of a digital asset each time the digital asset is sold to a subsequent owner. Such royalty payment arrangements may be implemented as a function with which the blockchain network is programmed, or using a reference table loaded into a computer memory element of the blockchain network, as a smart contract as described hereinabove, or by other means.

A further use case for cryptocurrency exchanges on a blockchain network is that such exchanges can protect transactions-similar to a manner in which a surety bond would. A surety bond or surety is a promise by a surety or guarantor to pay one party a certain amount if a second party fails to meet some obligation, such as fulfilling terms of a contract. The surety bond protects an obligee against losses resulting from a principal's failure to meet the obligation. As cryptocurrencies evolve from fringe investments to mainstream instruments, surety bonds may become an increasingly common requirement for those looking to trade in virtual currencies.

Ordinary surety bonds act as a contract between three parties: (i) an entity requesting the bond (principal), (ii) the bond's beneficiary (obligee), and (iii) a company issuing the bond. What a surety bond does is guarantee that the principal will fulfill its obligations, whether it's completing a long-term project or processing a financial transaction, or else forfeit the bond. Cryptocurrency surety bonds work in the same basic manner, ensuring that the principal performs cryptocurrency transactions as expected, or else forfeits the bond. In this case, the contract is between an entity handling a virtual currency transaction, a regulatory entity requiring the surety bond, and a surety bond provider.

A composable digital asset integrates two or more individual digital assets into a new combined form, which may be referred to as an asset cluster. An asset cluster may comprise components of similar or different types. For example, an asset cluster may include an element of fungible currency such as cryptocurrency, along with a NFT. Thus, combining an amount of cryptocurrency with an NFT effectively establishes a floor value for the NFT equal to the value of the fungible cryptocurrency.

Such composable assets may find applications in areas such as finance and gaming. An example embodiment of a gaming application of composable digital assets involves a piece of armor having a socket, into which a gem may be placed, creating an asset cluster. Asset clusters may be decomposed at any time such that the NFT and the currency item again become separate entities on a digital exchange platform.

Composable digital assets can provide liquidity for any digital asset or token. For example, a player of a game incorporating composable digital asset clusters may use a currency component of a cluster to set an instantaneous value at which to sell the cluster, such as to an automated market maker (AMM) associated with the game. Composable assets may be referenced or required by contracts or rules governing transactions on a digital exchange platform, such as smart contracts.

An AMM cryptographic system may be configured to provide liquidity to a platform enabling exchange of digital assets as described herein. The exchange platform may be decentralized. Liquidity may be provided using underlying collateral. The AMM cryptographic system may take in and store different forms of digital assets, such as loans, to be used as collateral in future exchanges on the platform. Such assets may be aggregated within a collateral pool, such that liquidity is pooled in association with the exchange platform. Liquidity may thus be pooled and aggregated on a blockchain supporting the collateral pool. Assets may be withdrawn from the collateral pool upon minting a collateral token. The collateral token may thus consolidate liquidity for an exchange within one protocol or contract. In addition, the collateral token may provide liquidity for a one-to-one exchange with a user looking to sell or redeem a user-held token.

In an embodiment, a composable asset control system implemented upon a platform may be configured to force an exchange to be performed on the platform such that the exchange is managed by an AMM cryptographic system. A machine learning (ML) oracle of the AMM cryptographic system may set a computational value for a collateral token, and may offer the collateral token for exchange at such a computational value, thus computing the market value for that token, rather than deferring to market forces. The AMM cryptographic system may function with either a bounded or an unbounded token supply, providing continuous liquidity. In addition, the AMM cryptographic system may be configured to measure supply and demand for tokens on the platform, including the collateral tokens. The AMM cryptographic system may be configured with an encoder/decoder. The AMM cryptographic system encoder may be configured to mint and/or encode collateral tokens.

The AMM cryptographic system may be implemented by any suitable protocol known to those of skill in the art, such as ERC-20 (Ethereum Request for Comments issue number 20), among other examples.

A digital asset marketplace may leverage a composable asset control system to enforce a contract governing transfer of tokens between electronic wallets. The contract may specify royalties to be paid to an original creator of a token upon transactions involving that token. In addition, the contract may include a revenue share table. The composable asset control system may be configured to enforce the contract regardless of network locations of two parties involved in a transaction, and regardless of whether or not the transaction is conducted within a digital asset marketplace. For example, even offline exchanges may be made transparently viewable from within the digital asset marketplace. The composable asset control system may be configured to serve any token creator. The composable asset control system may include a minimax recursive algorithm to facilitate a threshold value associate with the token.

In another embodiment, upon creation of a token, a threshold value of that token may be set within the digital asset marketplace. The composable asset control system may implement rules in conjunction with the threshold value to prevent a value of the token from experiencing dramatic changes characteristic of backdoor or offline transactions. As such, the threshold value may act as a floor price of the token required to activate any transaction involving the token. The composable asset control system may manage and approve or deny transactions accordingly. Rules such as threshold values may be based on a bounded percentage of a price change from a previous transaction. Such a composable asset control system may be implemented in a decentralized manner, for instance, with a smart contract. A central authority is thus not required.

Certain embodiments may offer techniques for verifying or checking an identity that protect, preserve, and maintain privacy. Safeguarding privacy within blockchain networks is an important consideration for traditional institutions such as banks and other financial institutions that may desire to interact with and/or launch smart contracts, for example, as part of digital asset transactions, but may also need to keep trade secrets and/or sensitive customer information etc. confidential. As to the latter, such institutions may also be required to comply with rules and/or regulations including, but not limited to, the Europe Union's General Data Protection Regulation (GDPR) and the United States' Health Insurance Portability and Accountability Act (HIPAA), among other examples.

In an example embodiment, the composable asset control system may be accomplished by use of, e.g., a “zero-knowledge proof” (ZKP). A zero-knowledge proof implementation in the composable asset control system ensures enforcement of encoded rules configured in NFT assets utilizing a technique whereby a first entity (or “prover”), such as first transacting entity, a first wallet etc., may cryptographically prove to a second transacting entity (or “verifier”) that the first entity possesses knowledge regarding certain information regarding the encoded rules in configured in the NFT, without also disclosing the actual contents of the information.

Zero-knowledge proofs may be interactive or non-interactive. An interactive ZKP requires interaction between a prover entity and a verifier entity involved in an NFT encoded rule enforcement transaction processed by the composable asset control system. A non-interactive ZKP may be constructed from any interactive scheme by relying on, e.g., a Fiat-Shamir heuristic, or any other suitable technique known to those of skill in the art.

According to an embodiment, a protocol implementing ZKPs may be presented as a transcript where a prover (first entity) responds to interactive inputs from a verifier (second entity). In one such embodiment, the interactive input may be in the form of one or more challenges such that responses from the prover will convince the verifier if and only if a statement is true, e.g., if the prover does possess certain asserted knowledge.

In the context of blockchain networks, according to some embodiments, by employing a ZKP, the only information divulged on-chain is that some piece of undisclosed information is (i) valid and (ii) known by the prover with a high degree of certainty. As such, in an embodiment, zero-knowledge proofs may be used by various blockchains to furnish privacy-maintaining digital asset transactions, whereby, for example, a transaction's amount, sender electronic wallet identifier, and receiver electronic wallet identifier are kept secret. Furthermore, some embodiments relate to oracle networks that provide smart contracts with access to off-chain data and/or computing infrastructure. Such oracle networks may also employ ZKPs to prove a certain fact about off-chain data, without divulging the data itself on-chain. A method used for performing non-interactive ZKPs may be as described in D. Unruh, “Non-Interactive Zero Knowledge Proofs in the Random Oracle Model,” in EUROCRYPT 2015, 2015, pp. 755-84, which is herein incorporated by reference in its entirety.

Further, a method for creating and executing ZKP applications in embedded systems may be as described in Salleras, et al., “ZPiE: Zero-Knowledge Proofs in Embedded Systems,” Mathematics, vol. 9, no. 20, p. 2569, 2021, which is herein incorporated by reference in its entirety.

A digital wallet, such as a hybrid multisignature digital wallet, may enable a licensed custodian or designee to provide signatures or keys required to approve a digital transaction. The custodian may approve transfers of tokens on digital exchange platforms such as blockchain platforms. A set of custodian signatures, potentially from multiple custodians, may be required to approve a transaction. Alternatively, the hybrid multisignature wallet may be configured in a one-of-many or a one-of-one setup, requiring only a single signature of one or more valid signatures from one or more custodians to approve the transaction. If a network allows a designated party to be a custodian, that party may enter into an agreement at a protocol level on the network to become a designated custodian. The hybrid multisignature wallet may be implemented in support of compliance operations. The custodian may facilitate recovery or replacement of lost signatures or keys, or of entire lost wallets.

The hybrid multisignature wallet may enable transactions such as token swaps and may facilitate transfer of tokens across multiple networks. Individual networks of the multiple networks may implement rigorous or lenient constraints upon transactions performed within the respective networks. Thus, a disparity may exist between two networks involved in a token transfer. The custodian may facilitate management of such a disparity. The custodian may perform functions characteristic of an automated escrow service in conjunction with a digital exchange platform.

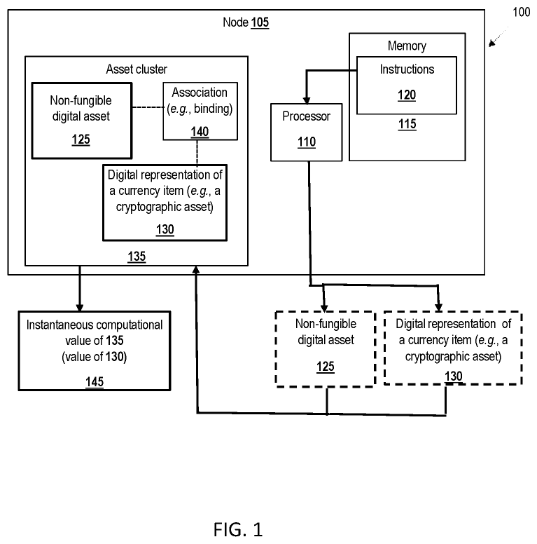

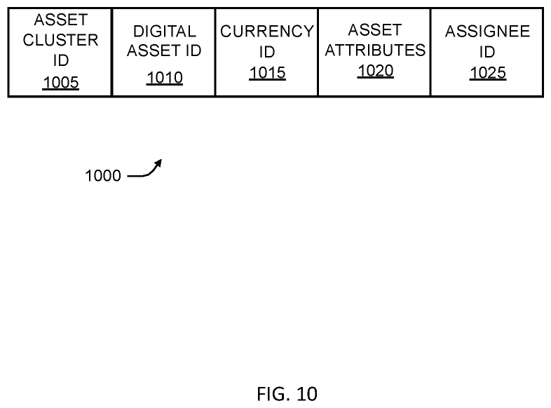

FIG. 1 is a block diagram of an example embodiment of a system 100 for establishing an instantaneous computational value of an asset cluster. The system 100 comprises a network node 105 including a processor 110 and a computer memory element 115 with software instructions 120 loaded thereon. The instructions 120, when executed, cause the processor 110 to obtain a non-fungible digital asset 125 and a digital representation of a currency item (e.g., a cryptographic asset) 130, such as a fungible token (e.g., a stablecoin or a cryptocurrency token native to an electronic ledger of a blockchain network). The instructions 120, when loaded, further cause the processor 110 to create an asset cluster 135 by recording an association (e.g., binding) 140 between the digital representation of the currency item 130 and the non-fungible digital asset 125. The processor 110 may record the association 140 by recording a data structure representing the asset cluster, such as the data structure 1000 described below with reference to FIG. 10. This data structure may be recorded to a ledger of a blockchain or to another data repository that is secured by a blockchain (i.e., information integrity is verified by the blockchain), such as a sidechain or a rollup. The processor 110 may further determine an instantaneous computational value 145 of the asset cluster 135 based on a value of the currency item 130, the value being associated with the asset cluster 135 instantaneously upon the creation of the asset cluster 135. For example, the processor 110 may determine the instantaneous computational value 145 as a minimum value (value floor) that is equal to the value of the currency item 130. According to an example embodiment, because the value of the currency item 130 may change or fluctuate (e.g., over time), the processor 110 may further iteratively quantify the instantaneous computational value of the asset cluster in response to such changes or fluctuations in the value of the currency item 130.

Thus, upon recording the association, the processor 110 may establish an instantaneous computational value 145 of the asset cluster 135 based on a value of the currency item 130. The dotted line representations of the non-fungible digital asset 125 and the currency item 130 indicate that said elements may originate externally to the node 105, but combine to form the asset cluster 135 at the node 105, either upon obtention by the processor 110, or thereafter.

By establishing the instantaneous computational value 145 for the asset cluster 135, the asset cluster 135 may benefit from improved liquidity for sale to other parties, such as via a digital asset exchange or a gaming platform. For example, in a gaming application, a NFT may represent ownership of an in-game item. However, a market for such NFTs may be unable to establish a value, or even an estimated value, of the given NFT, due to factors such as low trading volume. By creating an asset cluster that associates that NFT with a representation of a currency item (e.g., a fungible token), and determining a value of the cluster based on the currency item, the asset cluster possesses a value that facilitates trading of the cluster including the NFT.

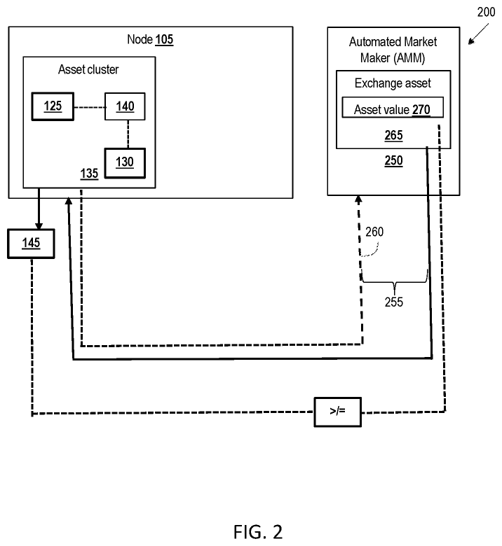

FIG. 2 is a block diagram of an example embodiment of a system 200 for establishing an instantaneous computational value of an asset cluster. The system 200 includes a network node such as the network node 105 of FIG. 1, with asset cluster 135 represented therein. The system 200 further includes an AMM 250 configured to interface with the network node 105 and to facilitate a transaction 255 in which an ownership interest 260 in the asset cluster 135 is transferred to the AMM 250 upon receipt, at the network node 105, of an exchange asset 265 having an asset value 270 that is equal to or greater than the instantaneous computational value 145 of the asset cluster 135.

Continuing with respect to FIG. 1, in some embodiments of the system 100, the network node 105 operates in connection with other network nodes in a blockchain network, and the association 140 is recorded in a ledger of the blockchain network. The instantaneous computational value 145 may be a minimum value. The currency item 130 may be at least a unit of cryptocurrency. The instructions 120, when executed, may further cause the processor 110 to separate a non-fungible digital asset 125 of an asset cluster 135 from a currency item 130 of the asset cluster 135 by nullifying the recorded association 140 therebetween.

In some embodiments, the network node 105 is configured to interface with an online gaming application presenting an environment that supports utilization of, or exchange of, the asset cluster 135 or a component thereof. The network node 105 may be configured to interface with an application or a website of a financial institution. The network node 105 may be configured to interface with an exchange platform implementing a transaction rule that references the asset cluster 135.

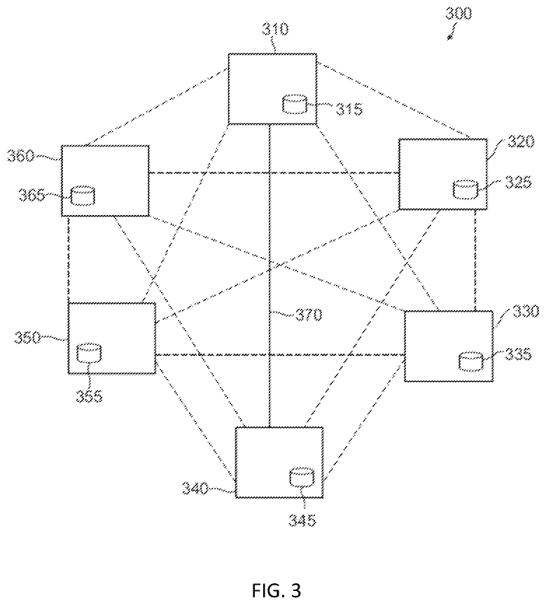

FIG. 3 is a block diagram of an example embodiment of a blockchain network 300, also referred to interchangeably herein as a distributed ledger network 300, that may be accessed according to an example embodiment. The blockchain network 300 may comprise the network node 105 of FIG. 1, and may comprise other network nodes, as disclosed above. The blockchain network 300 is a distributed ledger peer-to-peer (P2P) network and is valuable because this network enables trustworthy processing and recording of transactions without the need to fully trust any user (e.g., person, entity, program, and the like) involved in the transactions, reducing the need for trusted intermediaries to facilitate the transaction. Existing applications use the distributed ledger network 300 to transfer and record, in the form of blockchain based records, movement of tokens. Such blockchain based records form a cryptographically secured backlinked list of blocks.

The distributed ledger network 300 comprises multiple computing devices configured as nodes 310, 320, 330, 340, 350, 360 of the distributed ledger network 300. The nodes 310, 320, 330, 340, 350, 360 may be analogous to the node 105 of FIG. 1. Each node 310, 320, 330, 340, 350, 360 locally stores and maintains a respective identical copy 315, 325, 335, 345, 355, 365 of the blockchain ledger in memory communicatively coupled to the node. The nodes exchange messages within the distributed ledger network 300 to update and synchronize the ledger stored and maintained by each node. The nodes may also execute decentralized applications (dApps), such as via smart contracts, for processing the messages. A message transmission 370 from the node 310 to the node 340 may be used to exchange a token in the distributed ledger network 300 as shown in FIG. 3. The dotted lines between each set of nodes in the distributed ledger network 300 indicate similar transmissions that may be exchanged between any other set of nodes in the distributed ledger network 300. The messages may include a confirmed transfer for recording data associated with the token being transferred, such as a blockchain public key for each of the one or more parties participating in the transfer.

Referring back to FIG. 1, according to an example embodiment, the network node 105 may be deployed upon an Ethereum network; however, it should be understood that the node 105 may be deployed upon any suitable blockchain networks. Ethereum is a decentralized network of computers with two basic functions: (i) a blockchain that can record transactions and (ii) a virtual machine (VM), that is, an Ethereum Virtual Machine (EVM), that can produce smart contracts. Because of these two functions, Ethereum is able to support dApps. These dApps are built on the existing Ethereum blockchain, piggybacking off of its underlying technology. In return, Ethereum charges developers for the computing power in their network, which can only be paid in Ether (ETH), the only inter-platform currency. Depending on its purpose, a dApp may create ERC-20 tokens to function as a currency. According to an example embodiment, fungible tokens disclosed herein, e.g., the currency item 130, may be ERC-20 tokens or any other suitable fungible token.

The code of the smart contract may be uploaded on the EVM, that may be a universal runtime compiler or browser, to execute the smart contract's code. Once the code is on the EVM, the code may be the same across each Ethereum node to be run to check whether the conditions are met, such as a condition for the balance reaching the trade value prior to expiration of the expiration term.

Ethereum has a long history of developed standards. For example, ERC-20 is a standard that defines a set of six functions that other smart contracts within the Ethereum computer-implemented ecosystem can understand and recognize. ERC-20 is a protocol standard and in order to be ERC-20 compliant, the functions need to be included in the token's smart contract. ERC-20 outlines a specific list of rules that a given Ethereum-based token has to deploy, simplifying the process of programming the functions of tokens on Ethereum's blockchain. These include, for instance, how to transfer a token (by the owner or on behalf of the owner), such as may be employed for transferring fungible tokens of the buyer, and how to access data (e.g., name, symbol, supply, and/or balance) concerning the token.

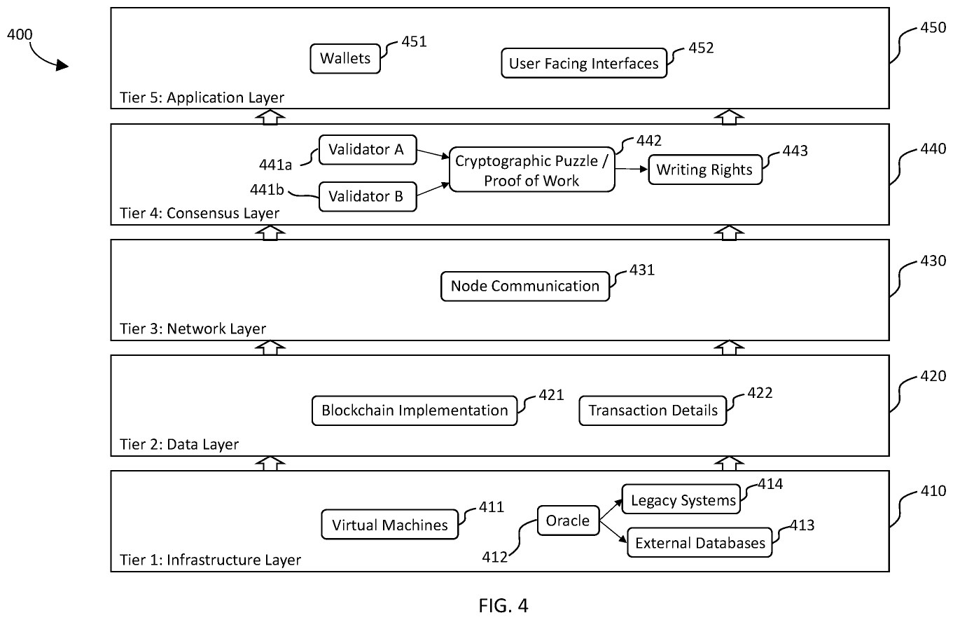

FIG. 4 is a simplified block diagram showing exemplary blockchain layers 400 according to an embodiment. Blockchain layers 400 may include infrastructure (tier 1) layer 410, data (tier 2) layer 420, network (tier 3) layer 430, consensus (tier 4) layer 440, and application (tier 5) layer 450. The infrastructure layer 410 may be a hardware layer and may include one or more VMs 411 and/or one or more oracles 412. A VM 411 may provide a runtime environment for transaction execution in the blockchain. In an embodiment, a VM 411 may be, for example, stack-based and may enable untrusted code to be executed by a global P2P network of computers. An oracle 412 may provide a third-party service that connects smart contracts executing on the blockchain with off-chain data sources. For example, an oracle 412 may query, verify, and/or authenticate one or more external data sources for the system 100 (FIG. 1) and/or the system 200 (FIG. 2). According to an embodiment, external data sources may include, e.g., one or more legacy systems 414 and/or databases 413.

According to an embodiment, an oracle node architecture, e.g., oracle 412, may be provided to serve ML models for smart contracts on a blockchain. Example smart contract technology may be implemented by any suitable known Web3 blockchain system, such as Ethereum, Cardano, Solana, BNB Smart Chain, Casper, Kaleido, or Fantom.

The oracle architecture may be referred to as a “ML oracle.” The ML oracle is useful to smart contract developers who want to incorporate ML models into their smart contracts. For example, a smart contract may distribute funds based on an algorithm, and the algorithm may include a ML model that forecasts sales of a product for a given week. The smart contract may invoke an inference call to a model on the ML oracle to obtain the forecast. As a further example, there are generative arts where the generative ML model may be an integral part of an artwork. Interaction with the model to generate new images may be part of a viewing experience. One well-known ML model type used by generative art is a generative adversarial network (GAN). Using the ML oracle, the ML model may become part of an NFT, thereby enabling an interactive viewing experience.

To summarize, in an embodiment, a smart contract may request an inference call to a ML model by identifying an ML model to call, such as by providing a hash value, and an input to the model. According to one such embodiment, a model file may be uploaded to, e.g., IPFS (InterPlanetary File System) or any other suitable known storage system, by a dApp developer and a model server may download the model file, e.g., using the hash value. For the ML model server to be generic enough to serve a wide range of models, it may also take as an input parameter a model type, e.g., PyTorch, TensorFlow, scikit-learn, or any other suitable known model type, as well as an input and output specification. The input may be data directly received from the calling smart contract, or it may be received indirectly via, e.g., an IPFS URI (Uniform Resource Identifier) or any other suitable identifier known to those of skill in the art. Similarly, the output may be sent back to the smart contract, or it may be uploaded to any suitable known storage system, including, but not limited to IPFS, and the, e.g., URI, may be sent to the smart contract. For example, a forecasting model may use the direct input/output (I/O) method. An indirect I/O method employing a known storage system such as IPFS may be commonly used by computer vision/imaging models, among other examples.

In an example embodiment, the system 100 and/or 200 may include a VM, e.g., VM 411, with a blockchain oracle, e.g., oracle 412.

Continuing with FIG. 4, data layer 420 may interface with infrastructure layer 410 and may include blockchain implementation 421 and transaction details 422. A blockchain is a decentralized, massively replicated database (distributed ledger), where transactions are arranged in blocks, and placed in a P2P network. The blockchain implementation 421 may include a data structure represented, for example, as a linked list of blocks, where transactions are ordered. The blockchain implementation 421's data structure may include two primary components-pointers and a linked list. Pointers are variables that refer to a location of another variable, and a linked list is a list of chained blocks, where each block has data and pointers to the previous block. Each block may contain a list of transactions that happened since a prior block. Transaction details 422 may contain information about transactions occurring on the blockchain.

The network layer 430 may interface with data layer 420 and may also be referred to as a P2P layer or propagation layer. One purpose of network layer 430 may be to facilitate node communication 431, such that nodes can discover each other and can communicate, propagate, and synchronize with each other to maintain a valid current state of the blockchain. A distributed P2P network, e.g., network layer 430, may be a computer network in which nodes are distributed and share the workload of the network to achieve a common purpose. Nodes in network layer 430 may carry out the blockchain's transactions.

The consensus layer 440 may interface with network layer 430 and may ensure that blocks are ordered, validated, and guaranteed to be in the correct sequence. A set of agreements between nodes in a distributed P2P network may be established by the consensus layer 440. The agreements result in consensus protocols or algorithms, which correspond to rules that nodes follow in order to validate transactions and create blocks in accordance with those rules. To validate a transaction, a validator, e.g., validator 441a or validator 441b, may perform a consensus algorithm, such as proof of work 442 or any other suitable algorithm known in the art. Performing the consensus algorithm may involve expending computational resources to solve a cryptographic puzzle 442. After being validated according to a consensus algorithm, a transaction may be written to the blockchain through a process of writing rights 443.

The application layer 450 may interface with consensus layer 440 and may include customized applications and services, such as electronic wallets 451. Further, application layer 450 may include (not shown): smart contracts, chaincode, and/or dApps. The application layer 450 may also include applications utilized by end users to interact with the blockchain. Such applications may be, e.g., one or more user facing interfaces 452. Further, such applications may include, for example (not shown): scripts, application programming interfaces (APIs), and/or frameworks.

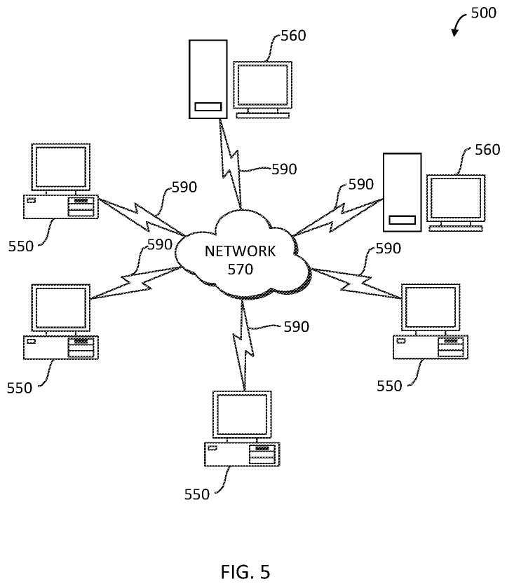

An example implementation of the system 100 (FIG. 1) and/or the system 200 (FIG. 2) may be implemented in a software, firmware, and/or hardware environment. FIG. 5 illustrates one such example digital processing environment 500 in which embodiments of the system 100 and/or the system 200 may be implemented. Client computer(s)/device(s) 550 and server computer(s)/device(s) 560 provide processing, storage, and input/output (I/O) devices executing application programs and the like.

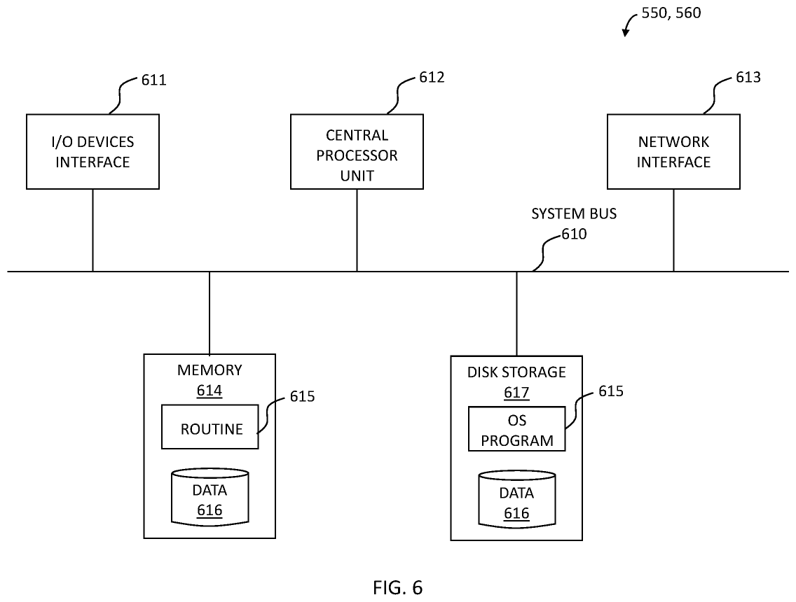

The client computer(s)/device(s) 550 may be linked 590 directly or through communications network 570 to other computing devices, including other client computer(s)/device(s) 550 and server computer(s)/device(s) 560. Referring to FIGS. 5 and 6 (the latter described in more detail hereinbelow), the network 570 utilizes the system 100 and/or the system 200 according to an embodiment of the invention, for providing privacy for transfer, e.g., the transaction 255 (FIG. 2), of digital assets, e.g., the non-fungible digital asset 125 (FIG. 1).

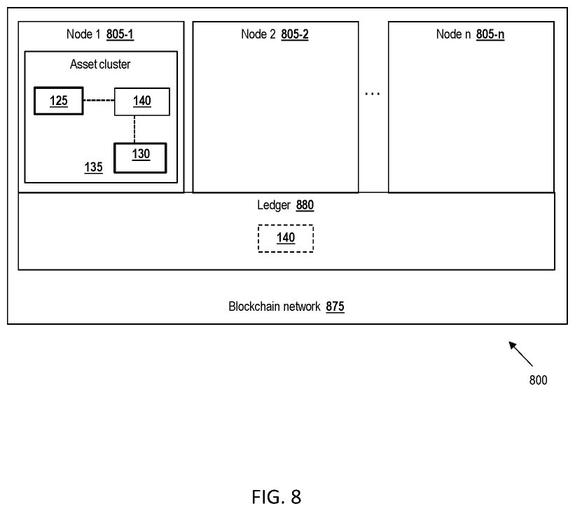

The communication network 570 may be part of a wireless or wired network, a remote access network, a global network (e.g., the Internet), a worldwide collection of computers, local area networks (LANs) or wide area networks (WANs), and gateways, routers, and switches that may use a variety of known protocols (e.g., TCP/IP, Bluetooth®, etc.) to communicate with one another. Moreover, the communication network 570 may also be a virtual private network (VPN) or an out-of-band (OOB) network or both. In addition, the communication network 570 may take a variety of forms, including, but not limited to, a blockchain network, a distributed ledger network, a data network, voice network (e.g., landline, mobile, etc.), audio network, video network, satellite network, radio network, and pager network. Other known electronic device/computer network architectures are also suitable. For example, the client computer(s)/device(s) 550 may include the nodes shown in FIG. 3, which run user applications that enable a user to communicate with an application to determine whether a user meets a work requirement. A blockchain network, such as blockchain network 875 (described in more detail hereinbelow in relation to FIG. 8), may be configured on each user device 310, 320 (FIG. 3) to store tokens. The client computers 350 (FIG. 3) of the computer-implemented system 100 (FIG. 1) and/or 200 (FIG. 2) may be configured with a trusted execution environment (TEE) or trusted platform module (TPM), where the application may be run and digital assets, e.g., the non-fungible digital asset 125 (FIG. 1), and/or tokens may be stored.

Referring again to FIG. 5, the server computer(s)/device(s) 560 of the computer-implemented system may be configured to include a server that that executes the application. For example, the application of server computer(s)/device(s) 560 may determine whether a user has satisfied a work requirement and produce a determination result and pair, in computer memory, e.g., memory 614 (FIG. 6), an indication of the determination result with an identifier of the user or an identifier of a digital asset of the user, such as an address of a node of a blockchain network accessible by the user. The application of server computer(s)/device(s) 560 also facilitates a transfer of a collateral token by moving the collateral token to, for example, a digital wallet implemented upon a blockchain network. For another example, the server computer(s)/device(s) 560 or the client computer(s)/device(s) 550 may comprise the peer computing devices (nodes) 310, 320, 330, 340, 350, 360 of the distributed blockchain ledger 300 of FIG. 3, which use smart contracts to execute and record transactions implemented via tokens.

FIG. 6 is a block diagram of any internal structure of a computing/processing node (e.g., client computer(s)/device(s) 550 or server computer(s)/device(s) 560) in the processing environment 500 of FIG. 5, which may be used to facilitate displaying audio, image, video, and/or data signal information. Each computer/device 550, 560 in FIG. 6 may contain a system bus 610, where a bus is a set of actual or virtual hardware lines used for data transfer among components of a computer or processing system. The system bus 610 may essentially be a shared conduit that connects different elements of a computer system (e.g., processor, disk storage, memory, I/O ports, etc.), thereby enabling transfer of data between elements or components.

Continuing with FIG. 6, attached to the system bus 610 is an I/O device interface 611 for connecting various input and output devices (e.g., keyboard, mouse, touch screen interface, displays, printers, speakers, audio inputs and outputs, video inputs and outputs, microphone jacks, etc.) to a computer/device 550, 560. Network interface 613 may allow a computer/device to connect to various other devices attached to a network, for example network 570 of FIG. 5. The memory 614 may provide volatile storage for computer software instructions 615 and data 616 used in some embodiments to implement software modules/components of the system 100 (FIG. 1) and/or the system 200 (FIG. 2).

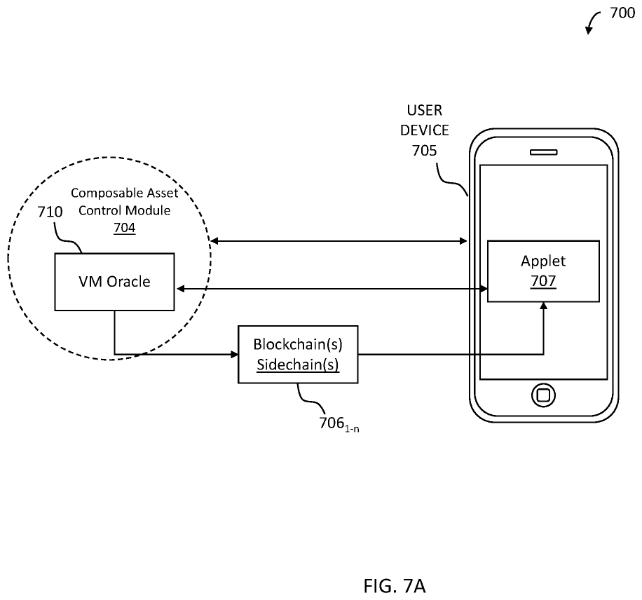

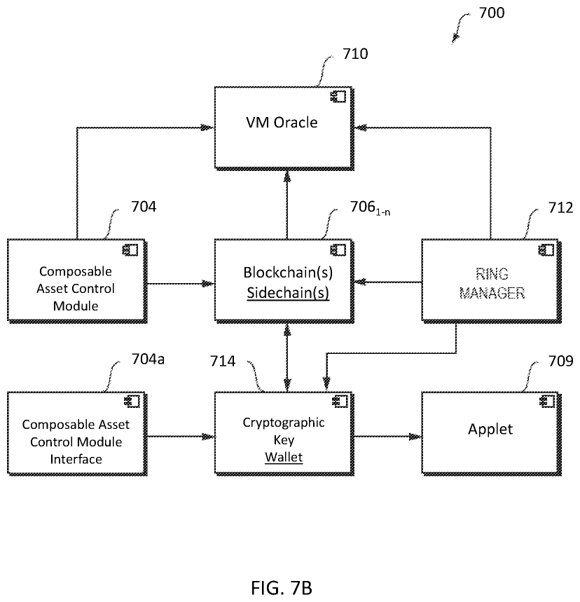

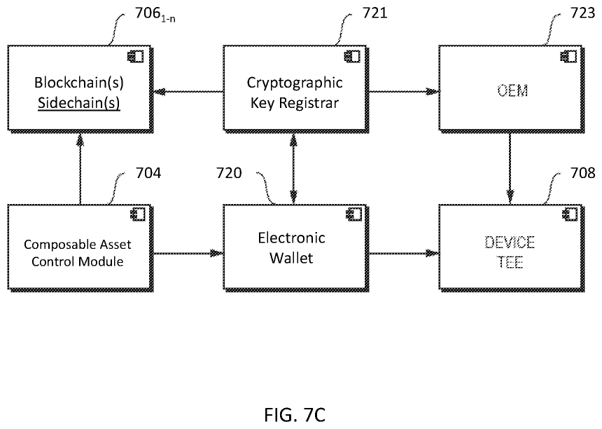

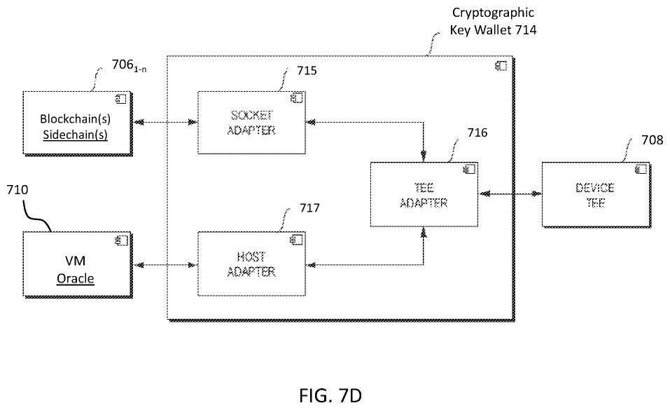

The software components 615, 616 of the system 100 and/or 200 (e.g., the node 105 (FIG. 1), the AMM 250 (FIG. 2), the composable asset module 704 (FIG. 7A), software components of the blockchain network 875 (FIG. 8), a minimax recursive algorithm, TEE, blockchain Layer 1 VM, encoder/decoder, ML oracle, wallet interface, applets, authentication site, cybersecurity controller, service applications, and the like) described herein may be configured using any suitable programming language known in the art, including any high-level, object-oriented programming (OOP) language, such as Python or Solidity. The computer-implemented system may include instances of processes that enable execution of transactions, e.g., the transaction 255 (FIG. 2), and recordation of such transactions. It should be understood that the terms “transaction” and “exchange” are herein used interchangeably, when used within a context of digitally transferring items of value, such as digital assets (e.g., the non-fungible digital asset 125 of FIG. 1), collateral assets, and/or collateral tokens, among entities associated with a blockchain network, e.g., the blockchain network 875. The computer-implemented system 100 and/or 200 may also include instances of a scoring engine and/or encoders/decoders, which can be implemented by, e.g., a server 560 and/or a client that communicates with the server 560, using, for example, SSL (secure sockets layer), HTTPS (Hypertext Transfer Protocol Secure), or any other suitable protocol known to those of skill in the art.

In an example mobile implementation, a mobile agent implementation of embodiments may be provided. A client-server environment may be used to enable mobile services using a network server, e.g., a server 560. It may use, for example, the Extensible Messaging and Presence Protocol (XMPP) protocol, or any other suitable protocol known to those of skill in the art, to tether an engine/agent 615 on a user device 550 to a server 560. The server 560 may then issue commands to the user device on request. The mobile user interface framework used to access certain components of the computer-implemented system 100 (FIG. 1) and/or 200 (FIG. 2) may be based on, e.g., XHP, Javalin, and/or WURFL (Wireless Universal Resource FiLe), or other suitable known framework(s), interface(s), and/or combinations thereof. In another example mobile implementation for the iOS operating system (OS) and its corresponding API, the Cocoa Touch API may be used to implement the client-side components 615 using Objective-C or any other suitable known high-level OOP language that adds Smalltalk-style messaging to the C programming language.

Disk storage 617 may provide non-volatile storage for the computer software instructions 615 (equivalently “OS program”) and the data 616 may be used to implement embodiments of the system 100 and/or 200. The system may include disk storage accessible to a server computer 560. The server computer may maintain secure access to records associated with the system 100 and/or 200. CPU (central processing unit) 612 may also be attached to the system bus 610 and provide for execution of computer instructions. In one example embodiment, the CPU 612 is a secure cryptoprocessor implemented as a dedicated microprocessor configured to execute the composable asset control system. The cryptoprocessor may be specialized to execute cryptographic algorithms within hardware to support the composable asset control system. Functions include such things as accelerating encryption algorithms that verify compliance of encoded rules related to an NET asset, enhanced tamper, and intrusion detection, enhanced data, key protection and security enhanced memory access and I/O to facilitate transactions across multiple blockchain systems.

In some embodiments, the processor routines 615 and the data 616 may be computer program products. For example, aspects of the system 100 and/or 200 may include both server-side and client-side components.

In other embodiments, authenticators/attesters may be contacted via, e.g., blockchain gaming systems, instant messaging applications, video conferencing systems, VoIP (voice over IP) systems, etc., all of which may be implemented, at least in part, in the software 615, 616. Further, in yet other embodiments, client-side components interfacing with the system 100 and/or 200 may be implemented as an API, executable software component, and/or integrated component of the OS configured to provide access to an electronic wallet on a TPM executing on a client device 550.

In one embodiment, the composable asset control system is implemented as an embedded virtual machine, preferably executing on one or more cryptoprocessors configured to support efficient and scalable processing of application-to-blockchain and blockchain-to-blockchain transactions. The cryptoprocessor may be a dedicated computer-on-a-chip or microprocessor for carrying out cryptographic transaction operations, embedded in a hardware security module (HSM) with security measures providing failsafe tamper resistance. The embedded cryptographic processor can be configured to output decrypted data onto a bus in a secure environment, in that embedded cryptoprocessor does not output decrypted data or decrypted program instructions in an environment where security cannot be maintained. The embedded cryptoprocessor does not reveal keys or executable instructions on a bus, except in encrypted form, and zeros keys by attempts at probing or scanning.

According to an example embodiment, the software implementations 615, 616 are computer program products, e.g., an application and smart contracts (generally referenced as 515), including a computer-readable medium capable of being stored on a storage device 617, which provides at least a portion of the software instructions for the computer-implemented system 100 and/or 200. Executing instances of respective software components of the system 100 and/or 200, such as instances of the application and/or smart contracts, may be implemented as computer program products 615, and may be installed by any suitable software installation procedure, as is well known in the art. In another embodiment, at least a portion of the system software instructions 615 may be downloaded over a wired and/or wireless connection via, for example, a browser SSL session or through an app (whether executed from a mobile or other computing device). In other embodiments, the system 100 and/or 200 software components 615 may be implemented as a computer program propagated signal product embodied on a propagated signal on a propagation medium (e.g., a radio wave, an infrared wave, a laser wave, a sound wave, or an electrical wave propagated over a global network such as the Internet, or other network(s) known in the art). Such carrier medium or signals may provide at least a portion of the software instructions for the computer-implemented system 100 and/or 200.

An example embodiment includes device code executed in a TEE or TPM. A TEE or TPM is a hardware environment that runs instructions and stores data outside a main OS of a device. This protects sensitive code and data from malware or snooping with purpose-built hardware governed by an ecosystem of endorsements, beginning with a device manufacturer. The system may perform checks on the TEE or TPM, such as executing BIOS (Basic I/O System) checks, to verify that folders (e.g., wallets) stored in the TEE/TPM have not been altered by malicious actors.

FIG. 7A is a simplified block diagram showing an example device authentication system 700 with components upon which the computer-implemented system 100 (FIG. 1) and/or 200 (FIG. 2) may operate according to an embodiment. With these system components 700, network nodes may make use of hardened encryption and the cryptographic key in endpoint user devices 705 through an API 704a to a composable asset control system 704. The user devices 705 may provide processing, storage, and/or I/O devices executing application programs and the like. In addition, further services may be provided built on these system components 700 for device management, backup, and/or attestation, etc. To support the system 100 and/or 200, the registration of identity cryptographic keys and a set of device management services for attestation, backup, and/or device grouping, are managed. The system components 700, e.g., cryptographic key wallet 714, may also interface with applet 709.

It would be the intent of the system 700 not to maintain mission critical data as in conventional approaches, but rather to provide a platform for seamless, yet secure, connections between composable asset control system 704 and user devices 705. On one end of the system is the VM oracle 710 that prepares an instruction for a user device 705 and at the other is system 700 which is applet 707 that can act on that instruction. A protocol may define how these instructions and replies are constructed.

According to an embodiment, system 700 may illustrate binding between a digital asset and multiple parties/devices. The system 700 may lock features of identity, transaction, and/or attestation to the hardware of respective user devices 705. In one example, the system 700 may provide a zero-knowledge proof attestation that a node implementing the composable asset control system minted a collateral token configured to consolidate liquidity within a blockchain protocol for an exchange, e.g., the transaction 255 (FIG. 2), of a digital asset, e.g., the non-fungible digital asset 125 (FIG. 1). In this way, the attestation can improve processing time of a given exchange transaction by allowing the system 700 to approve an exchange if the exchange is performed on or facilitated by the at least one node, thereby ensuring that the exchange is secure and that the composable asset control system provides liquidity to support the exchange of the digital asset.

In an embodiment, the system 700, shown in FIG. 7B, may use a secure socket, e.g., SSL or HTTPS, to maintain a persistent connection with devices. This channel may be used for pairing and other administrative attestation functions of the composable asset control system. The VM oracle 710 may be provided to/utilized on blockchain networks for simplifying the encoding of a transaction, e.g., the transaction 255 (FIG. 2). This VM oracle 710, for example, could be implemented in a programming language, such as a high-level, OOP language with dynamic semantics like Python.

A TEE may be implemented in a user device hardware security chip separate execution environment that runs alongside the rich OS and provides security services to that rich environment. The cryptographic keys and/or digital assets, e.g., the non-fungible digital asset 125 (FIG. 1), collateral assets, or collateral tokens may be stored in the TEE. The TEE offers an execution space that provides a higher level of security than a rich OS. The TEE may be implemented as a VM, on the user devices, and/or on the network nodes.

A ring manager 712 can be implemented as a service provided to end-users for managing rings (or clusters) to provide scalable execution and cross-chain deployment of composable asset control system(s) 704 across multiple blockchain systems. The composable asset control system(s) 704 may be grouped into a single identity and used to backup and endorse each other. Rings may be associated with other rings to create a network of devices including any oracles. The rings may be a collection of individual device public keys (as opposed to a new key). If there are not many shared devices in the network, the list of devices may be short because of the potential for increased computational and bandwidth resources that may be expended, and may introduce a time cost for encrypting a transaction, e.g., the transaction 255 (FIG. 2), with all cryptographic keys on a device list.

In an example embodiment, a device TEE 708 is a software program that executes in a hardware secured TEE. The device TEE 708 is specially designed to execute cryptographic functions without compromise from malware or even the device operator. OEM (Original Equipment Manufacturer) 723 is the entity that built the user device and/or a Trusted Application Manager (TAM) authorized to cryptographically vouch for the provenance of the device.

In an embodiment, when an electronic wallet 720 shown in FIG. 7C runs for the first time to process an NFT, it will ask the device TEE 708 to generate the cryptographic key. Each digital asset, e.g., the non-fungible digital asset 125 (FIG. 1), is signed by the node that deposits the asset into a locker with their signature and is thereby locked. For a node to then interact with the asset on the network on which it is locked, the node must unlock the asset with a cryptographic signature. Registration may involve confirmation from the device operator. The registrar may ask the device for a Device Measurement Record which includes one or more of the following: a composite value of the Platform Configuration Registers (PCRs) generated by the boot process, BIOS version, OS version, and GPS (Global Positioning System) location, among other examples. This data may be signed by the cryptographic key. It may be further signed by the registrar. The resulting data set may become the gold reference or reference value for future integrity checks. Confirmation from the device operator may be required in collecting the gold reference or reference value. This data set may be posted into a public cryptographic ledger. The public record may establish cryptographic proof of the time of registration along with the endorsement of the registrar. The registration may further include attribute data, such as location or company name or device make/model. The registration may reference a signed document that sets out the policy terms of the registrar at the time of registration. The cryptographic key registrar 721, or another trusted integrity server, may create a blockchain account key (a public/private key pair) that can be referenced as a signatory in a multi-signature transaction on the blockchain. A signatory may indicate that the value represented in the blockchain transaction cannot be spent or transferred unless co-signed by the registrar.

The blockchain(s)/sidechain(s) 706₁₋ₙ may be a JSON (JavaScript Object Notation) API written in Python, which uses the third-party agent/process private key to enroll the identity cryptographic keys of devices 705 and the system 700. During enrollment, the public key of the user device 705 or system 700 is recorded by the TEE applet 708. Enrollment enables the TEE applet 708 to pair a device 705 with the composable asset control system 704. In one embodiment, the result of pairing is that a user device 705 has a service public key, endorsed by a third-party agent/process and can therefore respond to composable asset control system 704 instructions.

In an embodiment, the cryptographic key wallet 714 of FIG. 7B may be composed of outward and inward-looking interfaces as shown in FIG. 7D. An inward-looking interface, TEE adapter 716, handles proprietary communications with the system 700. A host adapter 717 is provided to expose services to third-party applications. The host adapter 717 may present the interface of the cryptographic key wallet 714 through different local contexts, such as browsers or system services. Multiple realizations for diverse contexts are anticipated. A socket adapter 715 may connect the client environment blockchain(s)/sidechain(s) 706₁₋ₙ. The TEE adapter 716 may be the glue that pipes commands into the system 700. The cryptographic key wallet 714 may prepare message buffers that are piped to the system 700, and then synchronously awaits notification of a response event. The host adapter 717 may isolate the TEE adapter 716 from the host environment. The host adapter 717, in an embodiment, may operate in a potentially hostile environment. The host adapter 717's role may be to facilitate easy access to the system 700. Instructions from the composable asset control system 704 intended for the system 700 may be signed by the composable asset control system 704 and then passed through to the TEE adapter 716 and the system 700.

The blockchain(s)/sidechain(s) 706₁₋ₙ may have a special capability of being able to pair additional instances of composable asset control system(s) with device 705. Communications with the first blockchain(s)/sidechain(s) 706₁₋ₙ may be handled through the web API and preferably are authenticated. In one example, this is implemented with an API key. This may be implemented using an SSL key swap. In some embodiments, all requests are signed.

The system 700 provides robust security. The digital locker may be used to make it more difficult for an attacker to access a digital asset, e.g., the non-fungible digital asset 125 (FIG. 1), in the digital asset locker, as, if the attacker does not possess a valid cryptographic key, access to the locker will not be validated. Moreover, the system 700 may preferably be in near constant contact with all devices 705 through the socket adapter 715 shown in FIG. 7C.

In an embodiment, blockchain(s)/sidechain(s) 706₁₋ₙ may comprise several subcomponents. For example, each block on the blockchain(s)/sidechain(s) 706₁₋ₙ may contain hashes, a height, nonce value, confirmations, and/or a Merkle Root, among other examples.

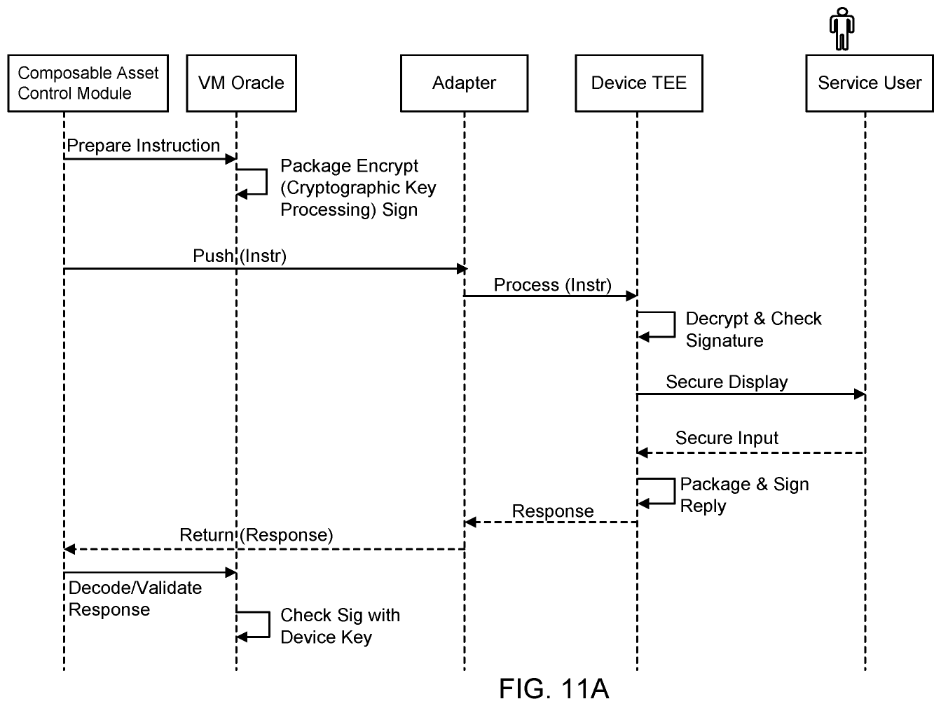

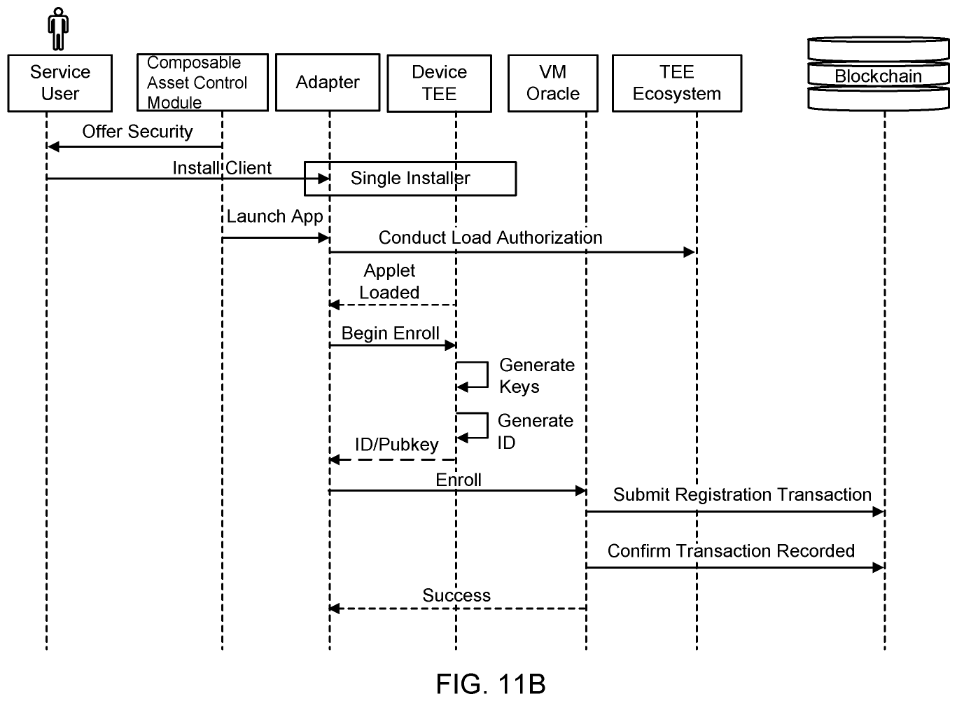

In an embodiment, a sequence of packaging and delivering an instruction is shown in FIG. 11A. The composable asset control system 704 may generate an instruction record with the help of the VM oracle 710 libraries. The instruction may include the type, the target device, and/or the payload. The instruction may be encoded with one or more cryptographic keys. The cryptographic key is fetched from the blockchain(s)/sidechain(s) 706₁₋ₙ by looking up the device registration record.

In an embodiment, device enrollment may be performed. An example enrollment process, shown in FIG. 11B, should be hassle free, or even transparent to the user. This embodiment may ensure that the system 700 is operating in a proper TEE.

FIG. 8 is a block diagram of an example embodiment of a system 800 for establishing an instantaneous computational value of a non-fungible digital asset. The system 800 includes a network node that may be referred to as Node 1 805-1. Node 1 805-1 may be configured as described with respect to the network node 105 of FIG. 1. Specifically, Node 1 805-1 may include an asset cluster 135 (FIG. 1) comprising a non-fungible digital asset 125 (FIG. 1) and a digital representation of a currency item 130 (FIG. 1), and an association 140 (FIG. 1) noted therebetween. Node 1 805-1 may operate in connection with other network nodes such as Node 2 805-2 and Node n 805-n in a blockchain network 875. The association 140 may be recorded in a ledger 880 of the blockchain network 875. The blockchain network 875 may be configured to communicate and/or transact with other blockchain networks in a cross-chain manner, as so described hereinabove.

Turning again to FIG. 1, the instantaneous computational value 145 may be a minimum value. The currency item 130 may include at least a unit of cryptocurrency. The instructions 120, when executed, may further cause the processor 110 to separate the non-fungible digital asset 125 of the asset cluster 135 from the currency item 130 of the asset cluster 135 by nullifying the recorded association 140 therebetween.

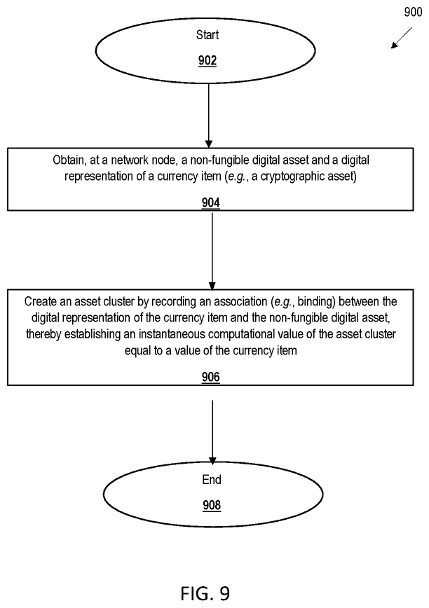

FIG. 9 is a flow diagram showing an example embodiment of a method 900 of establishing an instantaneous computational value of a non-fungible digital asset. In some embodiments, the method 900 starts 902 by obtaining 904, at a network node, e.g., the network node 105 (FIG. 1), a non-fungible digital asset, e.g., the non-fungible digital asset 125 (FIG. 1), and a digital representation of a currency item, e.g., the digital representation of a currency item 130 (FIG. 1). The method 900 further includes creating 906 an asset cluster, e.g., the asset cluster 135 (FIG. 1), by recording an association, e.g., the association 140 (FIG. 1), between the digital representation of the currency item (e.g., a cryptographic asset) and the non-fungible digital asset, thereby establishing an instantaneous computational value, e.g., the instantaneous computational value 145 (FIG. 1), of the asset cluster equal to a value of the currency item 130. Having established said instantaneous computational value, the method 900 subsequently ends 908. Alternative method embodiments parallel those described above in connection with the example computer-based system embodiments.

FIG. 10 is a table illustrating an example data structure 1000 representing an asset cluster, e.g., the asset cluster 135 (FIG. 1), that may be recorded to a blockchain. With reference to FIG. 1, for example, the processor 110 may cause the data structure 1000 to be recorded to a ledger of a blockchain network, e.g., the ledger 880 of the blockchain network 875 (FIG. 8), when recording the association integral to the asset cluster as described above. As shown, the data structure 1000 may include an asset cluster identifier (ID) 1005 that identifies and distinguishes the asset cluster from other assets. A digital asset ID 1010 identifies the non-fungible digital asset (e.g., NFT) integrated into the asset cluster, and a currency ID 1015 may identify the digital representation of a currency item (e.g., a cryptographic asset) integrated into the asset cluster. For example, the currency ID 1015 may identify a token type and a corresponding amount (e.g., 1.2 ETH). In an example embodiment, the digital asset ID 1010 and/or the currency ID 1015 may include a cryptographic hash value. To continue, an asset attributes segment 1020 may identify one or more attributes of the asset cluster, such as metadata regarding its recordation on the blockchain, an identifier of associated smart contract(s), and other properties governing the value, transfer, and/or use of the asset cluster. For example, the asset attributes 1020 may include data governing use of the non-fungible digital asset (e.g., an integrated NFT) within a gaming application, platform, or service. Lastly, an assignee ID 1025 may identify the present owner of the asset cluster, and may correspond to an account within a blockchain ledger.

Although the data structure 1000 includes several data segments 1005-1025, alternative embodiments may omit one or more data segments, or may include additional data segments. For example, the asset cluster may integrate a plurality of NFTs or other digital assets, each of which may be represented in a respective segment of the data structure 1000.

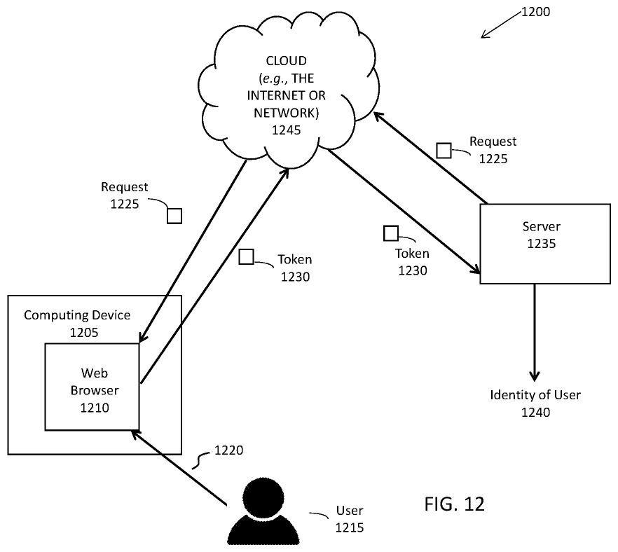

FIG. 12 shows an example of a user identification system 1200 according to an embodiment. A user 1215 interacts via user input 1220 with a website displayed via a web browser 1210 running on computing device 1205, such as clicking an advertisement on the displayed website. The interaction is communicated to server (token server) 1235. For example, a transparent pixel or script may be placed on the displayed website to communicate the interaction to the server 1235.

An application executing on the server 1235 determines whether the user 1215 is a software robot or a person user by issuing a request 1225 to web browser 1210 to produce a token. The request 1225 is sent over a network 1245. In response to request 1225, web browser 1210 produces a token 1230 on computing device 1205. The token 1230 is sent to the server 1235 over network 1245. The application executing on server 1235 determines (e.g., using a computational challenge) a computational cost of producing the token 1230. In some embodiments, the computational cost of producing the token 1230 is based on the time taken to produce the token 1230. Based on the computational cost of producing the token 1230, the application on server 1235 determines (deciphers) whether the user 1215 is a software robot or a person user. In some embodiments, proving the computational cost of producing the token 1230 at the computing device 1205 is performed by an independent third party, rather than the application executing on server 1235.

An application that determines whether the user 1215 is software robot or a person user may also exist locally on the computing device 1205. In this embodiment, it would not be necessary to send request 1225 or token 1230 over a network 1245.

In some embodiments, the request 1225 is issued in response to particular user engagement in the web browser 1210 and based on user engagement metrics, including mouse movements by the user. The request 1225 can also be issued in response to an elapsed period of time or issued by a web service.

In some embodiments the application on server 1235 of FIG. 12 calculates a confidence score and metrics associated with whether the user 1215 operating computing device 1205 is at least in part by a software robot or a person user. Once the application on server 1235 determines whether user 1215 is a software robot or a person user, the application on server 1235 returns the identity of the user 1240 and a calculated confidence score, which is associated with a likelihood of whether computing device 1205 is being operated by a software robot or a person user. Thus, the calculated confidence score indicates a confidence value regarding the user identification. The confidence score helps the relying party determine a measure of confidence about the identity of the user 1240.

The confidence score can be based on many different factors. One factor is the computational cost of the produced token 1230. If the proven computation cost is low (below a threshold value), the confidence score may be increased. Further, if computing device 1205 is a server, the computational cost is higher than if the computing device 1205 is an individual machine, and thus the confidence score may be increased. The confidence score may be based on the time it took computing device 1205 to produce the token 1230. For example, longer times (e.g., above a time threshold) for producing token 1230 may be associated with a higher likelihood that the identity of the user 1240 is a software robot and a lower likelihood that the identity of the user 1240 is a person user. In another embodiment, the confidence score is increased if the computing device 1205 includes a TPM.

According to some embodiments, produced token 1230 is captured in a cookie. In an embodiment, the captured produced token and the computational cost of the captured produced token 1230 are time sensitive and expire after a period of time. Captured cookies can sign cookies generated in the future thus, building up proof of whether the web browser 1210 running on computing device 1205 is being operated by a person user or a bot. The building up of proof results in a longer block chain, making it increasingly difficult for a web browser running on a machine that is operated by a bot to continue to produce tokens.

In some embodiments, the confidence score may be calculated to further consider the confirmed purchase activities of the user. The score may increase when determined that a user is a verified purchaser who previously completed an online purchase. The proof of a user being an online purchaser, such as a retrieved proof of purchase cookie associating the user's identity to an entry in a database of confirmed purchases may increase the confidence score. For example, a retrieved proof of purchase cookie associating the user's identity particularly to a persistent entry in a block chain database of confirmed purchases may further increase the confidence score. That is, the trusted confirmation of the user as a verified purchaser may be associated with a higher likelihood (confidence) that the identity of the user is a person (rather than a software robot).

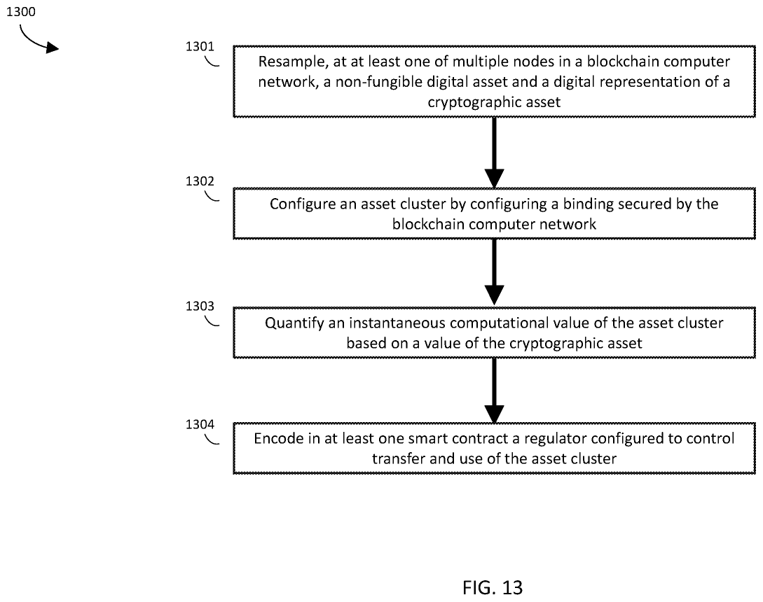

FIG. 13 is a flow diagram of an exemplary computer-based system/method 1300 for establishing an instantaneous computational value of an asset cluster according to an embodiment. The system/method 1300 begins by resampling 1301, at at least one of multiple nodes in a blockchain computer network, a non-fungible digital asset and a digital representation of a cryptographic asset. The system/method 1300 continues by configuring 1302 an asset cluster by configuring a binding secured by the blockchain computer network. The binding may be configured to computationally pair the resampled 1301 digital representation of the cryptographic asset and the resampled 1301 non-fungible digital asset. In turn, the system/method 1300 quantifies 1303 an instantaneous computational value of the asset cluster based on a value of the cryptographic asset. The system/method 1300 then encodes 1304 in at least one smart contract a regulator configured to control transfer and use of the asset cluster. The regulator may be further configured to control the asset cluster based on the quantified 1303 instantaneous computational value of the asset cluster.

Further example embodiments disclosed herein may be configured using a computer program product; for example, controls may be programmed in software for implementing example embodiments. Further example embodiments may include a non-transitory computer-readable medium containing instructions that may be executed by a processor which, when loaded and executed, cause the processor to complete methods described herein. It should be understood that elements of the block and flow diagrams may be implemented in software or hardware, such as via one or more arrangements of circuitry of FIG. 6, disclosed above, or equivalents thereof, firmware, a combination thereof, or other similar implementation determined in the future. In addition, the elements of the block and flow diagrams described herein may be combined or divided in any manner in software, hardware, or firmware. If implemented in software, the software may be written in any language that can support the example embodiments disclosed herein. The software may be stored in any form of computer-readable medium, such as random-access memory (RAM), read-only memory (ROM), compact disk read-only memory (CD-ROM), and so forth. In operation, a general-purpose or application-specific processor or processing core loads and executes software in a manner well understood in the art. It should be understood further that the block and flow diagrams may include more or fewer elements, be arranged or oriented differently, or be represented differently. It should be understood that implementation may dictate the block, flow, and/or network diagrams and the number of block and flow diagrams illustrating the execution of embodiments disclosed herein.

It should be understood that the term “blockchain” as used herein includes all forms of electronic, computer-based distributed ledgers. These include consensus-based blockchain and transaction-chain technologies, permissioned and un-permissioned ledgers, shared ledgers and variations thereof. While Bitcoin and Ethereum may be referred to herein for the purpose of convenience and illustration, it should be noted that the disclosure is not limited to use with the Bitcoin or Ethereum blockchains and alternative blockchain implementations and protocols fall within the scope of the present disclosure.

It should also be noted that not all currently known distributed ledger systems utilize linear blockchains as such. Some known blockchain implementations utilize lattice or mesh data structure(s), and some utilize directed acyclic graphs (DAGs).

The teachings of all patents, published applications, and references cited herein are incorporated by reference in their entirety.

While example embodiments have been particularly shown and described, it will be understood by those skilled in the art that various changes in form and details may be made therein without departing from the scope of the embodiments encompassed by the appended claims.

1. A computer-based system for establishing an instantaneous computational value of an asset cluster, the computer-based system comprising:
a blockchain computer network including multiple nodes,
at least one of the multiple nodes configured to execute a composable asset control system,
the composable asset control system configured to:
resample, at the at least one of the multiple nodes, a non-fungible digital asset and a digital representation of a cryptographic asset;
configure an asset cluster by configuring a binding secured by the blockchain computer network, the binding configured to computationally pair the resampled digital representation of the cryptographic asset and the resampled non-fungible digital asset;
quantify an instantaneous computational value of the asset cluster based on a value of the cryptographic asset; and
encode in at least one smart contract a regulator configured to control transfer and use of the asset cluster, the regulator further configured to control the asset cluster based on the quantified instantaneous computational value of the asset cluster.

2. The computer-based system of claim 1, wherein:
the at least one of the multiple nodes includes a secure cryptoprocessor implemented as a dedicated microprocessor configured to execute the composable asset control system; and
the composable asset control system is embedded on the secure cryptoprocessor.

3. The computer-based system of claim 1, wherein:
the composable asset control system is further configured to resample the non-fungible digital asset and the digital representation of the cryptographic asset by generating a first identifier (ID) for the non-fungible digital asset and a second identifier (ID) for the cryptographic asset.

4. The computer-based system of claim 3, wherein:
the first identifier (ID) includes a first cryptographic hash value; and
the second identifier (ID) includes a second cryptographic hash value.

5. The computer-based system of claim 1, wherein:
the regulator is further configured to computationally assign at least one attribute of the asset cluster.

6. The computer-based system of claim 5, wherein:
the at least one attribute of the asset cluster includes: (i) metadata relating to recordation of the asset cluster on the blockchain computer network, (ii) an identifier of the at least one smart contract, (iii) another property governing the instantaneous computational value, the transfer, or the use of the asset cluster, (iv) data governing use of the non-fungible digital asset in a gaming application, or (v) a combination thereof.

7. The computer-based system of claim 1, wherein:
the regulator is further configured to computationally assign an owner node of the asset cluster.

8. The computer-based system of claim 7, wherein:
the regulator is further configured to record a pairing between a user account of the owner node and the asset cluster in an electronic ledger of the blockchain computer network.

9. The computer-based system of claim 1, wherein the composable asset control system is further configured to:
iteratively quantify the instantaneous computational value of the asset cluster responsive to a change in the value of the cryptographic asset.

10. The computer-based system of claim 1, wherein:
the at least one of the multiple nodes is further configured to execute an automated market maker (AMM) cryptographic system,
the automated market maker (AMM) cryptographic system configured to facilitate a transaction with the at least one of the multiple nodes by:
upon receipt, at the at least one of the multiple nodes, of an exchange asset having an asset value that is equal to or greater than the instantaneous computational value of the asset cluster, transferring an ownership interest in the asset cluster to the automated market maker (AMM) cryptographic system.

11. The computer-based system of claim 1, wherein the at least one of the multiple nodes is further configured to operate in connection with other nodes of the multiple nodes of the blockchain computer network.

12. The computer-based system of claim 1, wherein the instantaneous computational value is a minimum value.

13. The computer-based system of claim 1, wherein the cryptographic asset includes at least a unit of cryptocurrency.

14. The computer-based system of claim 1, further comprising:
an online application configured to present an environment that supports utilization of, or exchange of, the asset cluster or a component thereof; and
wherein the at least one of the multiple nodes is further configured to interface with the online application.

15. The computer-based system of claim 1, wherein the at least one of the multiple nodes is further configured to interface with an application or a website of an asset transaction facilitation platform.

16. The computer-based system of claim 1, wherein the composable asset control system is further configured to:
separate the non-fungible digital asset of the asset cluster from the digital representation of the cryptographic asset of the asset cluster by nullifying the binding secured by the blockchain computer network.

17. The computer-based system of claim 1, wherein the at least one of the multiple nodes of the blockchain computer network is further configured to interface with an exchange platform, the exchange platform configured to implement a transaction rule that governs the transfer and the use of the asset cluster.

18. The computer-based system of claim 1, wherein the instantaneous computational value is equal to the value of the cryptographic asset.

19. The computer-based system of claim 1, wherein the cryptographic asset includes a fungible token native to an electronic ledger of the blockchain computer network.

20. The computer-based system of claim 1, wherein the composable asset control system is further configured to:
configure the binding secured by the blockchain computer network by recording a data structure to a data repository secured by the blockchain computer network, the data structure including an identifier of the resampled non-fungible digital asset and an identifier of the resampled digital representation of the cryptographic asset.

21. A computer-implemented method for establishing an instantaneous computational value of an asset cluster, the computer-implemented method comprising:
resampling, at at least one of multiple nodes in a blockchain computer network, a non-fungible digital asset and a digital representation of a cryptographic asset;
configuring an asset cluster by configuring a binding secured by the blockchain computer network, the binding configured to computationally pair the resampled digital representation of the cryptographic asset and the resampled non-fungible digital asset;
quantifying an instantaneous computational value of the asset cluster based on a value of the cryptographic asset; and
encoding in at least one smart contract a regulator configured to control transfer and use of the asset cluster, the regulator further configured to control the asset cluster based on the quantified instantaneous computational value of the asset cluster.

22. The computer-implemented method of claim 21, further comprising:
at the at least one of the multiple nodes, implementing a secure cryptoprocessor as a dedicated microprocessor configured to execute a composable asset control system, the composable asset control system configured to perform the resampling, the configuring the asset cluster, the quantifying, and the encoding; and
embedding the composable asset control system on the secure cryptoprocessor.

23. The computer-implemented method of claim 21, further comprising:
resampling the non-fungible digital asset and the digital representation of the cryptographic asset by generating a first identifier (ID) for the non-fungible digital asset and a second identifier (ID) for the cryptographic asset.

24. The computer-implemented method of claim 23, further comprising:
generating the first identifier (ID) for the non-fungible digital asset by generating a first cryptographic hash value; and
generating the second identifier (ID) for the cryptographic asset by generating a second cryptographic hash value.

25. The computer-implemented method of claim 21, further comprising:
configuring the regulator to computationally assign at least one attribute of the asset cluster.

26. The computer-implemented method of claim 25, wherein computationally assigning the at least one attribute of the asset cluster includes:
computationally assigning: (i) metadata relating to recordation of the asset cluster on the blockchain computer network, (ii) an identifier of the at least one smart contract, (iii) another property governing the instantaneous computational value, the transfer, or the use of the asset cluster, (iv) data governing use of the non-fungible digital asset in a gaming application, or (v) a combination thereof.

27. The computer-implemented method of claim 21, further comprising:
configuring the regulator to computationally assign an owner node of the asset cluster.

28. The computer-implemented method of claim 27, further comprising:
configuring the regulator to record a pairing between a user account of the owner node and the asset cluster in an electronic ledger of the blockchain computer network.

29. The computer-implemented method of claim 21, further comprising:
iteratively quantifying the instantaneous computational value of the asset cluster responsive to a change in the value of the cryptographic asset.

30. The computer-implemented method of claim 21, further comprising:
executing an automated market maker (AMM) cryptographic system, the automated market maker (AMM) cryptographic system configured to facilitate a transaction with the at least one of the multiple nodes by:
upon receipt, at the at least one of the multiple nodes, of an exchange asset having an asset value that is equal to or greater than the instantaneous computational value of the asset cluster, transferring an ownership interest in the asset cluster to the automated market maker (AMM) cryptographic system.

31. (canceled)

32. The computer-implemented method of claim 21, further including iteratively quantifying the instantaneous computational value of the asset cluster responsive to a change in the value of the cryptographic asset;
wherein the instantaneous computational value is a minimum value;
wherein the cryptographic asset includes at least a unit of cryptocurrency.

33. (canceled)

34. The computer-implemented method of claim 21, further comprising:
configuring the at least one of the multiple nodes to operate in connection with other nodes of the multiple nodes of the blockchain computer network;
interfacing, via the at least one of the multiple nodes, with an online application; and
within an environment presented by the online application, performing at least one of: (i) utilizing the asset cluster or a component thereof and (ii) exchanging the asset cluster or the component thereof.

35. The computer-implemented method of claim 21, further comprising:
interfacing, via the at least one of the multiple nodes, with an application or a website of an asset transaction facilitation platform; and
separating the non-fungible digital asset of the asset cluster from the digital representation of the cryptographic asset of the asset cluster by nullifying the binding secured by the blockchain computer network.

36. (canceled)

37. The computer-implemented method of claim 21, further comprising:
interfacing, via the at least one of the multiple nodes, with an exchange platform, the exchange platform configured to implement a transaction rule that governs the transfer and the use of the asset cluster;
wherein the instantaneous computational value is equal to the value of the cryptographic asset.

38. (canceled)

39. The computer-implemented method of claim 21, further including configuring the binding secured by the blockchain computer network by recording a data structure to a data repository secured by the blockchain computer network, the data structure including an identifier of the resampled non-fungible digital asset and an identifier of the resampled digital representation of the cryptographic asset;
wherein the cryptographic asset includes a fungible token native to an electronic ledger of the blockchain computer network.

40. (canceled)

41. A non-transitory computer program product for establishing an instantaneous computational value of an asset cluster, the non-transitory computer program product comprising a computer-readable medium with computer code instructions stored thereon, the computer code instructions being configured, when executed by a processor, to cause the processor to:
implement, upon a blockchain computer network including multiple nodes, a composable asset control system configured to:
resample, at at least one of the multiple nodes, a non-fungible digital asset and a digital representation of a cryptographic asset;
configure an asset cluster by configuring a binding secured by the blockchain computer network, the binding configured to computationally pair the resampled digital representation of the cryptographic asset and the resampled non-fungible digital asset;
quantify an instantaneous computational value of the asset cluster based on a value of the cryptographic asset; and
encode in at least one smart contract a regulator configured to control transfer and use of the asset cluster, the regulator further configured to control the asset cluster based on the quantified instantaneous computational value of the asset cluster.
